(19) United States
(12) Patent Application Publication
(10) Pub. No.: US 2008/0100871 A1
(43) Pub. Date: May 1, 2008

(54) Image processing circuit, computer-readable medium, image processing method, and image processing apparatus

(75) Inventor: Masaru Iida, Hachioji-shi (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 11/904,169

(22) Filed: Sep. 26, 2007

(30) Foreign Application Priority Data
Oct. 31, 2006 (JP) 2006-296341

(51) Int. Cl. H04N 1/405; G06F 15/00

(52) U.S. Cl. 358/3.13; 358/1.9; 358/3.06

(57) ABSTRACT

Disclosed is an image processing circuit, comprising: a converting section to perform an infective conversion for a gradation data of an input image to a gradation data indicating any one of dither patterns having the number of gradations higher than the number of gradations of the input image; a dither processing section to select the gradation data in the dither patterns, corresponding to coordinate information of a dot of an image processing target in the input image; and a screening processing section to determine a gradation data of a dot of an output image based on the gradation data for which the infective conversion is performed by the converting section and the gradation data selected by the dither processing section.

### CROSS-REFERENCE TO RELATED APPLICATIONS

The present U.S. patent application claims a priority under the Paris Convention of Japanese patent application No. 2006-296341 filed on Oct. 31, 2006, which shall be a basis of correction of an incorrect translation.

### BACKGROUND

1. Field of the Invention

The present invention relates to an image processing circuit, a computer-readable medium, an image processing method, and an image processing apparatus.

2. Description of Related Art

Conventionally, an image forming apparatus, such as an ink jet printer and a laser beam printer, performs screening processing to an input image. The screening processing is processing to express a richer gradation with a prescribed certain number of gradations, and is performed by an image processing circuit or a program.

The screening processing determines the on-states and the off-states of dots (pixels) of an output image by using a dither threshold value arrangement 340 as shown in FIG. 15. To put it concretely, the screening processing compares the density values (gradation data) of dots of an input image with threshold values stored in the dither threshold value arrangement 340, and determines the on-states and the off-states of the output image based on the comparison results. Hereby, various density gray tones can be expressed, for example, in a tone expression based on two gradations of black and white.

Moreover, the density conversion of an input image is performed before the performance of screening processing. The density conversion is performed by using a density conversion table (tone reduction curve; hereinafter referred to as “TRC”), which is a data table associating the density values of an input image (hereinafter referred to as “input density values”) with the density values of an output image (hereinafter referred to as “output density values”). In an ordinary operational mode (hereinafter referred to as “standard mode”), the density conversion is performed by using a TRC 220 shown in FIG. 16.

Moreover, a saving mode (such as a toner saving mode) for suppressing the consumption of toning materials such as toners to be used in image forming has been put to practical use. In the saving mode, the density conversion is performed by using a TRC 221 shown in FIG. 16. Now, the following technique is known as a technique pertaining to the saving mode. That is, in a technique of suppressing the density of an output image disclosed in Japanese Patent Application Laid-Open Publication No. 2006-82251, when a toner saving function is set, a standard gamma curve is modified in accordance with a suppressing curve, and an output density value corresponding to an input density value is set based on the standard gamma curve after the modification for suppressing the output image.

Now, because a density conversion is performed by using the TRC 220 shown in FIG. 16 at the time of the standard mode, the density conversion can be performed without lessening the number of gradations of the 256 gradations of an input image. However, when the TRC 221 is used at the time of the saving mode, different input density values are sometimes converted into the same output density value because the output density values are compressed, and the density values of the output image are lessened to 128 gradations.

Moreover, even by the technique of the Japanese Patent Application Laid-Open Publication No. 2006-82251, because the output density values are lessened in the toner saving function by the modification of the standard gamma curve, the number of the gradations of an output image is lessened. As described above, because the density values of an input image is lessened in the saving mode by the related art, density values cannot be exhibited to their utmost limits that the image forming apparatus can reproduce.

### SUMMARY

The present invention was made in order to solve the above problems, and aims the realization of an image processing circuit and the like capable of keeping the number of gradations of an input image even in the case of obtaining an output image by lowering the density of the image.

To achieve at least one of the abovementioned objects, an image processing circuit reflecting one aspect of the present invention, comprises: a converting section to perform an injective conversion for a gradation data of an input image to a gradation data indicating any one of dither patterns having the number of gradations higher than the number of gradations of the input image;

a dither processing section to select the gradation data in the dither patterns, corresponding to coordinate information of a dot of an image processing target in the input image; and a screening processing section to determine a gradation data of a dot of an output image based on the gradation data for which the injective conversion is performed by the converting section and the gradation data selected by the dither processing section.

Preferably, the image processing circuit further comprises a switching section to switch a conversion rule of the converting section, wherein

the converting section performs the infective conversion for the gradation data of the input image to the gradation data indicating any one of the dither patterns in accordance with the conversion rule switched by the switching section.

Preferably, the dither processing section comprises:

a dither storing unit to store the gradation data which are different among dots in a predetermined coordinate system; and

a pattern selecting unit to select the gradation data corresponding to the coordinate information of the dot of the image processing target in the input image, from the dither storing unit.

Preferably, the gradation data includes identification values for identifying each of the dither patterns, and

the screening processing section determines the gradation data of the dot of the output image based on whether or not the identification value converted by the converting section is equal to or more than the identification value selected by the dither processing section.

To achieve at least one of the abovementioned objects, an image processing apparatus reflecting another aspect of the present invention, comprises: a dither threshold value matrix having a reproducing ability for N gradations; and

a look-up table to perform an injective conversion for a gradation data having M gradations lower than the N gradations to a gradation data having the N gradations, wherein

the injective conversion is performed for the gradation data of an input image having the M gradations to the gradation data having the N gradations by using the look-up table, and a screening processing is executed for the gradation data for which the injective conversion is performed, by using the dither threshold value matrix.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing an example of the functional configuration of an image forming apparatus;

FIG. 2 is a block diagram showing an example of the functional configuration of an image control unit, an image memory, and a screening module;

FIG. 3 is a diagram showing a data configuration example of a normal look-up table (LUT);

FIG. 4 is a diagram showing a data configuration example of a toner saving LUT;

FIG. 5 is a diagram showing the conversion characteristics of the normal LUT and the toner saving LUT;

FIG. 6 is a diagram showing a data configuration example of a dither dot order arrangement;

FIGS. 7A, 7B, 7C, 7D, 7E, 7F, 7G, 7H, and 7I are diagrams showing examples of dither patterns generated based on the dither dot order arrangement;

FIG. 8 is a first diagram showing a correlation between dither pattern numbers and image density values;

FIG. 9 is a second diagram showing a correlation between the dither pattern numbers and the image density values;

FIG. 10 is a block diagram sowing an example of the functional configuration of an image control unit, an image/tag memory, and a screening module in a first modification;

FIG. 11 is a block diagram showing an example of the functional configuration of an image memory and a screening module in a second modification;

FIG. 12 is a block diagram showing an example of the functional configuration of a client terminal;

FIG. 13 is a flow chart for illustrating screening processing;

FIGS. 14A, 14B, and 14C are diagrams showing the processing method of the screening processing;

FIG. 15 is a diagram showing an example of the data configuration of an dither dot order arrangement in related art; and

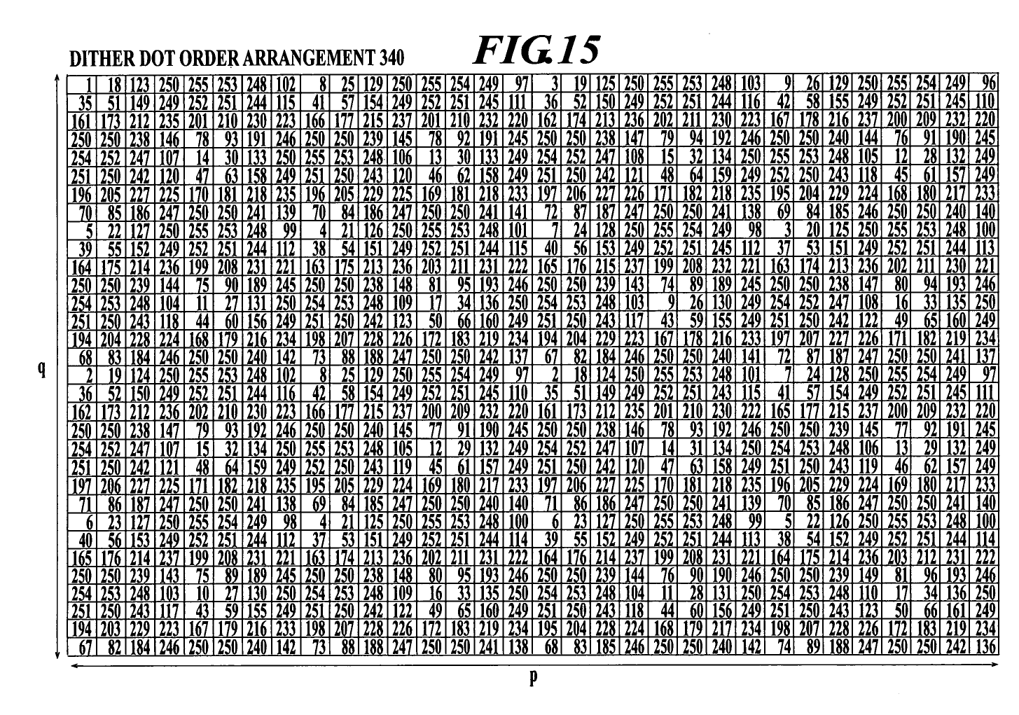

FIG. 16 is a diagram showing the conversion characteristics of a density conversion table in the related art.

### DETAILED DESCRIPTION OF THE PREFERRED EMBODIMENTS

### First Embodiment

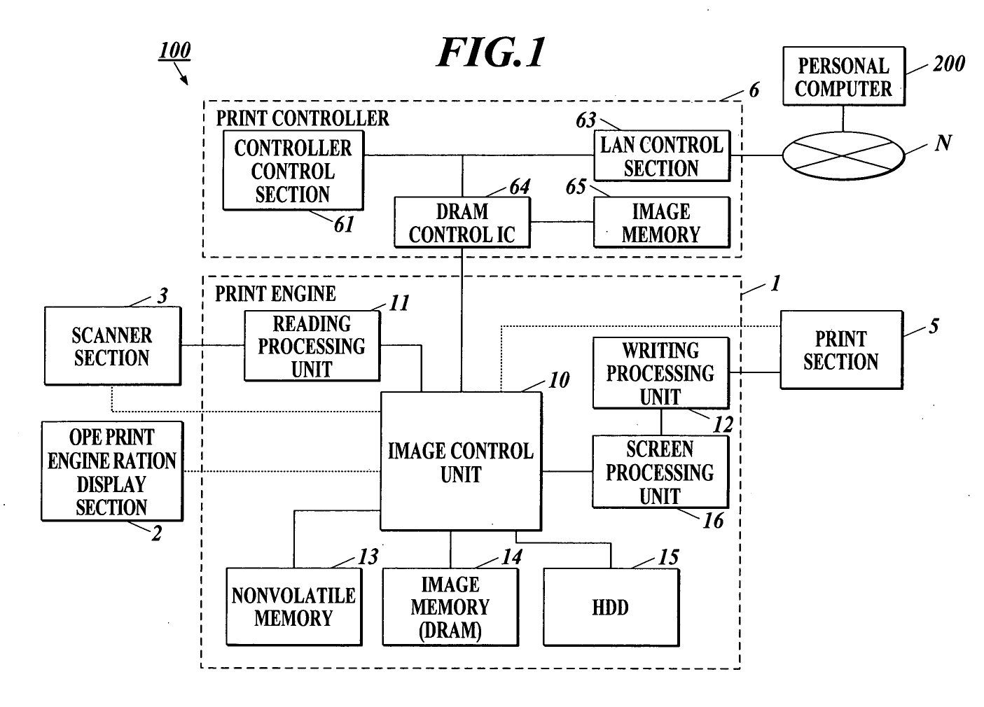

In the following, a first embodiment in the case of applying an image processing circuit according to the present invention to an image forming apparatus 100 shown in FIG. 1 is described in detail with reference to FIGS. 1-11. Incidentally, the image forming apparatus 100 as an image processing apparatus of the first embodiment can suitably be applied to an apparatus forming an image on a print medium, such as a printer, a facsimile (FAX), a copier, and a multi-function peripheral (MFP).

FIG. 1 is a block diagram showing an example of the functional configuration of the image forming apparatus 100. The image forming apparatus 100 is configured to be able to perform data communication with a client terminal 200 through a network N as shown in FIG. 1, and performs image forming on a print medium based on the image data transmitted from the client terminal 200 or the image data of a document read with a scanner section 3.

When a user inputs a printing starting instruction of a produced document or image into the client terminal 200, print data is generated based on the printing starting instruction, and the generated print data is transmitted to the image forming apparatus 100.

There are the standard mode and the toner saving mode, which are described above, as the operational modes of the image forming apparatus 100. The toner saving mode is an operational mode for suppressing the consumption of toner, and the operational mode is set based on a user's operation.

Moreover, as shown in FIG. 1, the image forming apparatus 100 comprises a print engine 1, an operation display section 2, a scanner section 3, a print section 5, and a print controller 6.

The print controller 6 comprises a controller control unit 61, a local area network (LAN) control unit 63, a dynamic random access memory (DRAM) control integrated circuit (IC) 64, and an image memory 65.

The controller control unit 61 is a function unit performing an instruction to each function unit, the control of data communication, and various kinds of image processing of an image data, and comprises a central processing unit (CPU), a read only memory (ROM), a RAM, and the like.

Moreover, the controller control unit 61 performs a data conversion to convert the print data, which has been received from the client terminal 200, into bitmap image data by performing rasterizing processing to the received print data in a form of a prescribed page description language. Further, in a preferred embodiment, the controller control unit 61 outputs print mode command (e.g., a standard mode, a toner saving mode, and so on), which may be included in the received print data, to the image control unit 10. The image control unit 10 will be mentioned in detail later.

The LAN control unit 63 comprises a communication interface, such as a network interface card (NIC) and a modem, for connecting the print controller 6 with the network N, and performs data communication with an external device, such as the client terminal 200.

The image memory 65 comprises, for example, a DRAM, and is a data area in which the print data transmitted from the client terminal 200 and the bitmap image data are temporarily stored. The bitmap image data may be compressed before being stored in the image memory 65, and expanded when it is extracted from the image memory 65. The DRAM control IC 64 is a function unit controlling the reading and the writing of the print data and the bitmap image data from and to the image memory 65, and data communication with the print engine 1 through a bus.

In FIG. 1, the print engine 1 comprises an image control unit 10, a reading processing unit 11, a writing processing unit 12, a nonvolatile memory 13, an image memory 14, a hard disk drive (HDD) 15, and a screen processing unit 16.

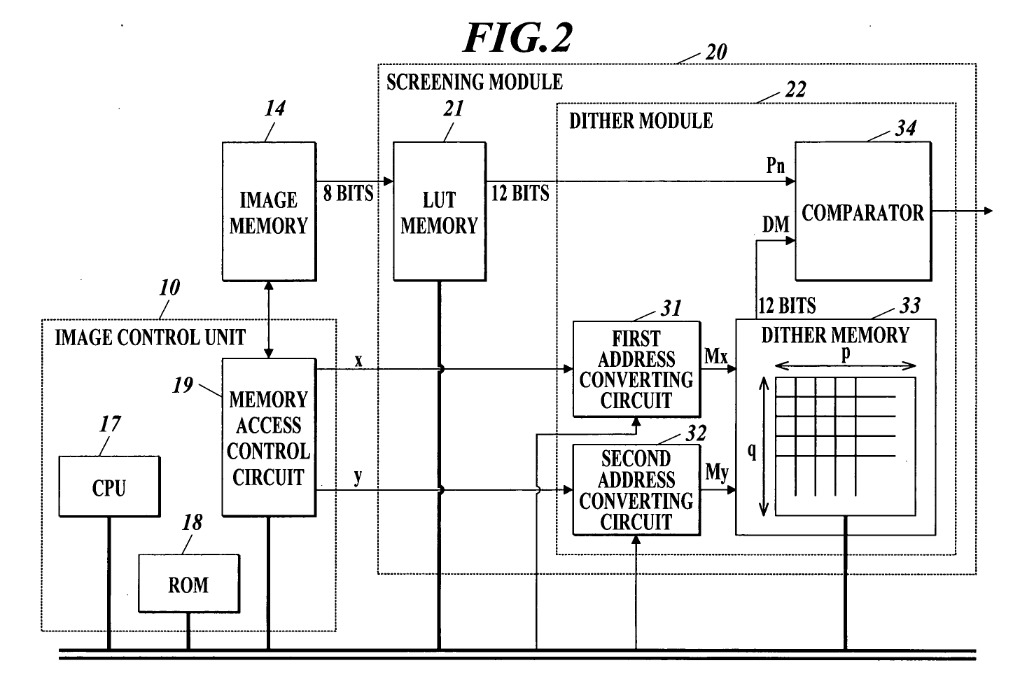

The image control unit 10 is the function unit that wholly controls each function unit such as the operation display section 2, the scanner section 3, and the print section 5, and performs various kinds of image processings. The image control unit 10 comprises a CPU 17, a ROM 18, and a memory access control circuit 19, which are shown in FIG. 2. To put it concretely, the image control unit 10 performs the processing in accordance with the various programs stored in the ROM 18 and the HDD 15 based on an operation signal output from the operation display section 2 to control each function unit.

Moreover, the image control unit 10 performs data communication with the print controller 6 though the bus. When the image control unit 10 receives image data from the print controller 6, the image control unit 10 stores the image data in the image memory 14.

The reading processing unit 11 converts the analog image signals read by the scanner section 3 into digital image data, and outputs the digital image data to the image control unit 10. The image control unit 10 compresses the digital image data to make the image memory 14 temporarily store the compressed image data.

The writing processing unit 12 generates drive signals controlling writing into the print medium of the print section 5 based on image data, and outputs the generated drive signals to the print section 5. The image control unit 10 expands the image data stored in the image memory 14, and makes the image memory 14 once store the expanded image data. Then, the image control unit 10 reads an uncompressed image data page by page basis from the image memory 14, and makes the screen processing unit 16 perform the screening processing of the read image data. After that, the image control unit 10 makes the writing processing unit 12 convert the image data into drive signals.

The nonvolatile memory 13 comprises a semiconductor memory or the like, from and to which data can be read and written, and stores various kinds of set data and the like, which pertain image forming. The image memory 14 comprises, for example, a DRAM, and includes a compression memory, which temporarily stores a compressed image data, and a page memory, which temporarily stores an uncompressed image data before printing. The HDD 15 stores the image data read from the scanner section 3 and the image data received from the client terminal 200.

The screen processing unit 16 is the function unit performing screening processing to the image data for which the rasterizing processing is carried out by the print controller 6, and the screen processing unit 16 comprises a screening module 20, shown in FIG. 2. Incidentally, the details of the screening module 20 will be described later.

The operation display section 2 comprises a liquid crystal display (LCD), an operation panel, and the like. The operation display section 2 performs the display control of the LCD based on an instruction of the image control unit 10, and outputs an operation signal input from the operation panel to the image control unit 10.

The LCD performs the displays of various setting screens, the states of images, the operation situations of respective functions, and the like, on the screen thereof in accordance with instructions of display signals input from the image control unit 10. The operation panel includes operation keys and a touch panel, and outputs operation signals according to the depression operations of the operation keys and abutting operations against the touch panel by a user to the image control unit 10. The user operates the operation keys and the touch panel of the operation display section 2 to set an operational mode of the image forming apparatus 100.

The scanner section 3 comprises a scanner, and performs the drive control of a charge coupled device (CCD) and the like based on an instruction of the image control unit 10. The scanner is equipped with a platen glass sheet, the CCD, and a light source. The light source illuminates a document and scans the same. The reflected light of the illuminated light is focused on the CCD to form an image. The CCD performs the photoelectric conversion of the incident light to read the image of the document, and outputs the analog image signals of the image to the reading processing unit 11.

The print section 5 comprises a laser diode (LD), a photosensitive drum, an electric charger, a developing device, a transferring unit, a fixing device, a paper feed tray feeding transfer paper (a print medium), feed rollers for conveying the transfer paper along a conveying path conveying the transfer paper, and the like. The print section 5 performs image forming based on an instruction of the image control unit 10.

Specifically, the print section 5 performs the paper feeding of transfer paper from the paper feed tray of the paper size, for example, specified at the time of the execution of a job, and conveys the transfer paper onto the conveying path. The print section 5 then charges the surface of the photosensitive drum with the electric charger, and radiates laser lights from the LD onto the surface of the photosensitive drum based on drive signals input from the writing processing unit 12. The print section 5 then forms an electrostatic latent image on the photosensitive drum, and the developing device makes toner adhere to an area including the electrostatic latent image on the surface of the photosensitive drum. Next, the transferring unit transfers toner to the conveyed transfer paper to form an image, and the fixing device fixes the toner image. After that, the transfer paper is ejected onto a copy receiving tray or the like.

FIG. 2 is a block diagram showing an example of the functional configuration of the image control unit 10, the image memory 14, and the screening module 20. As shown in FIG. 2, the image control unit 10 comprises the CPU 17, the ROM 18, and the memory access control circuit 19.

The image memory 14 stores the image data that is developed to a bitmap of the resolution for image forming and has gradation data per a dot. The image data in the present embodiment has 256 gradations of 8 bits per dot.

The memory access control circuit 19 is a circuit controlling the access to the image data stored in the image memory 14. Specifically, the memory access control circuit 19 controls the image memory 14 to sequentially transmit image data to the screening module 20 based on an instruction from the CPU 17, and outputs the coordinate information (x-coordinate, y-coordinate) of the dot transmitted in synchronization with the transmission of the image data to a dither module 22.

Incidentally, the transmission of image data from the image memory 14 and the coordinate outputting of coordinate information from the memory access control circuit 19 are executed in synchronization with a not-shown clock signal.

Moreover, the screening module 20 comprises a look up table (LUT) memory 21, and a dither module 22, which includes a comparator 34, a first address converting circuit 31, a second address converting circuit 32, and a dither memory 33. The screening module 20 performs a screening processing to the image data input from the image memory 14 to output the processed image data to the writing processing unit 12.

The LUT memory 21 is a memory for storing LUTs, and comprises, for example, a nonvolatile memory or the like. The LUT is a data table storing the density data according to the number of gradations of image data (the gradation data as input density values; the M gradations=256; 8 bits) and dither pattern numbers Pn (the N gradations=1025; 11 bits) in the state of associating them in an injective manner, and the LUT is used at the time of converting density data into a dither pattern number Pn. Incidentally, as the data to be transmitted from the LUT memory 21 to the comparator 34 in the example of FIG. 2, it is possible to handle the data of 12 bits on the hardware thereof, but the present embodiment uses 11 bits, which can specify 1025 gradations as the dither pattern numbers Pn.

The dither pattern number Pn is an identification value for identifying a plurality of dither patterns uniquely, and has a higher number of gradations than the number of gradations of an input density value. Hereupon, the dither pattern indicates a dot pattern of an output image obtained at the time of performing the screening processing of an image in which the gradations are n (n is an integer within a range of from 0 to 1024) over a wide range by using a dither threshold value matrix of the dither memory 33, and 1025 types of dither patterns can be obtained as the “n” gradations change from 0 to 1024.

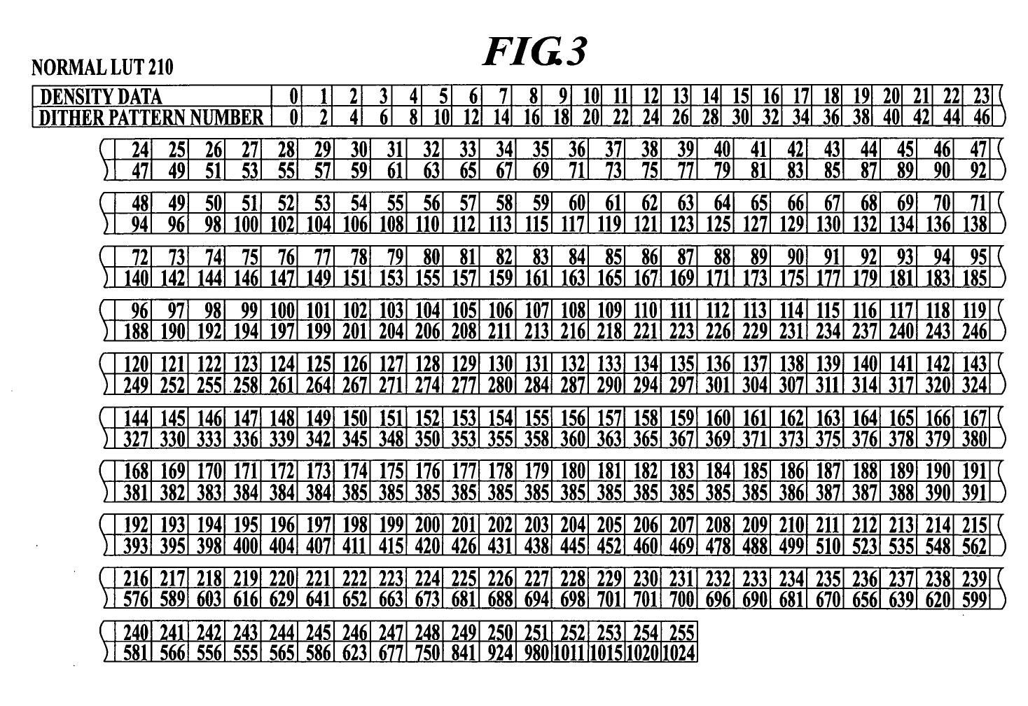

The dither pattern number Pn is expressed by a number of gradations within a range of from 0 to 1024 of 11 bits, and is associated with the density data of 256 gradations in an injective manner. Consequently, the dither pattern number Pn can be said to be the one obtained by converting input 8-bit density data into 12-bit density data. Incidentally, in FIG. 3, the dither pattern number Pn is expressed in 1025 gradations of 11 bits, but the dither pattern number Pn may also be expressed 4097 gradations of 12 bits. The number of gradations can suitably be changed according to the design of hardware.

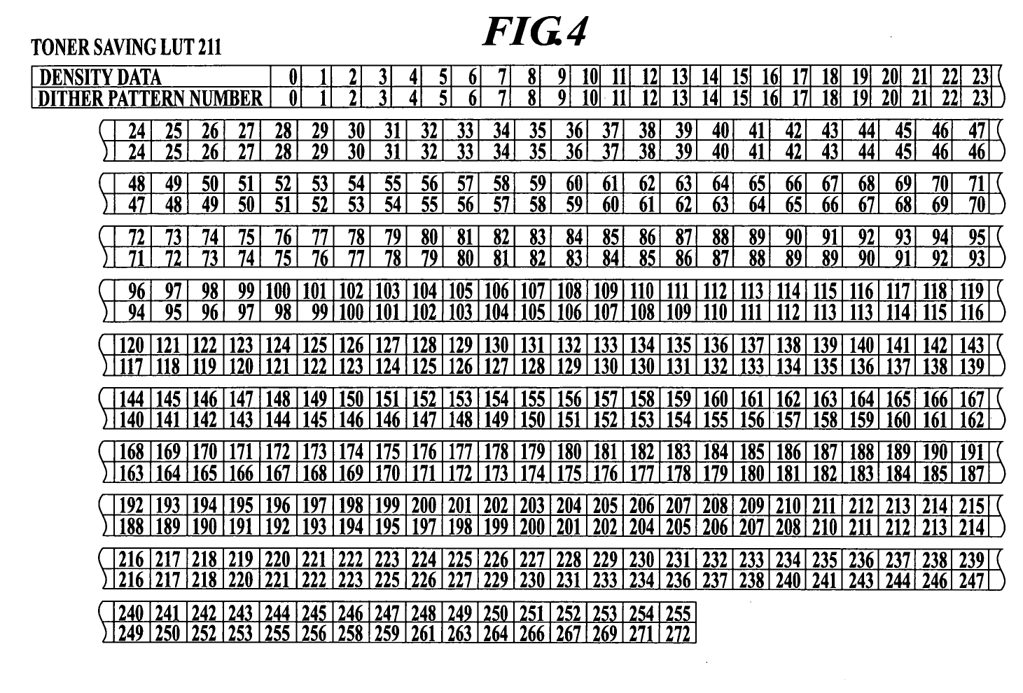

LUTs based on instructions of the CPU 17 are written in the LUT memory 21, and either a normal LUT 210 shown in FIG. 3 or a toner saving LUT 211 shown in FIG. 4 is written in the present embodiment. These normal LUT 210 and toner saving LUT 211 are previously stored, for example, in the ROM 18.

FIG. 3 is a diagram showing a data configuration example of the normal LUT 210. According to the FIG. 3, in the normal LUT 210, density data and dither pattern numbers Pn are stored in the state of being associated with each other. In the normal LUT 210, the numbers of gradations of the density data are from 0 to 255, and the dither pattern numbers Pn are set to be 1025 gradations from 0 to 1024, which exceed the numbers of gradations of the density data.

FIG. 4 is a diagram showing a data configuration example of the toner saving LUT 211. According to the FIG. 4, in the toner saving LUT 211, density data from 0 to 255 and dither pattern numbers Pn having the numbers of gradations from 0 to 272 are stored in the state of being associated with each other. The gradation range of the dither pattern numbers Pn stored in the toner saving LUT 211 is on the lower gradation (lower density) side than the gradation range of the dither pattern numbers Pn of the normal LUT 210, and is not lower than the numbers of gradations of the density data. The gradation range means the range of the numbers of gradations covered by the dither pattern numbers Pn and the density data here.

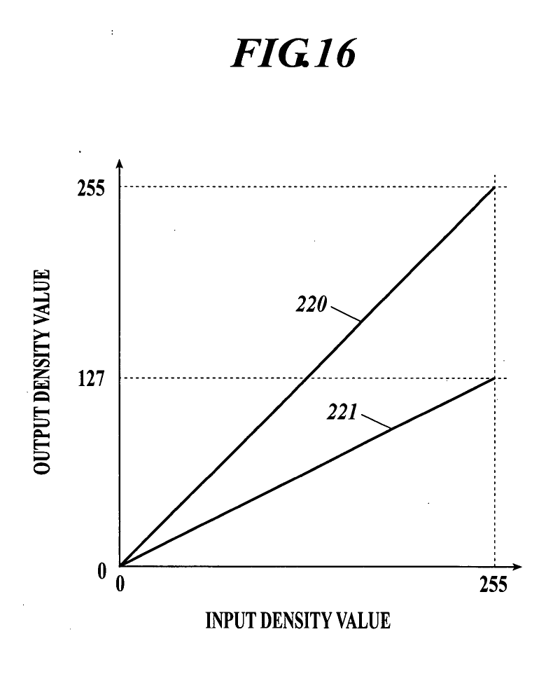

By using such a toner saving LUT 211, the density data of image data can be converted into the dither pattern numbers Pn equal to or more than the number of gradations of the density data without converting the density data into the values smaller than the number of gradations (for example, the output density values of FIG. 16).

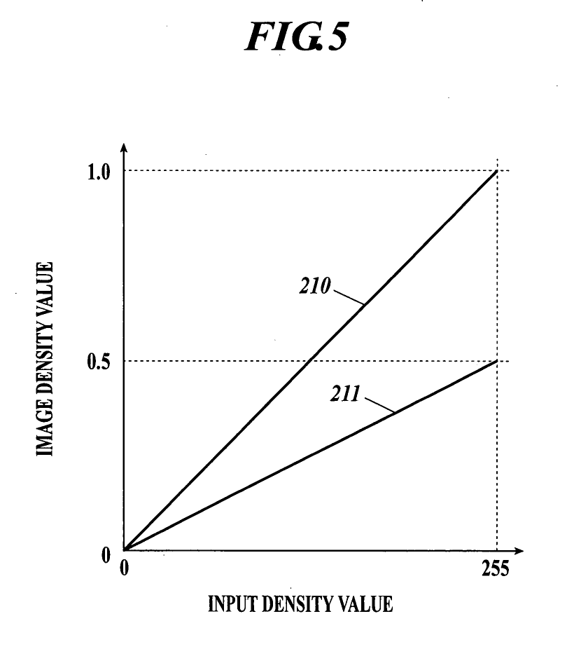

FIG. 5 is a diagram showing the conversion characteristics of the normal LUT 210 and the toner saving LUT 211. In FIG. 5, the abscissa axis indicates input density values, and the ordinate axis indicates the density values of the image actually formed on a print medium by the image forming apparatus 100 (hereinafter referred to as “image density value ΔEn”). Incidentally, the image density value ΔE indicates the color difference between the formed image and the surface of the print medium as a density value.

When the conversion characteristic of the normal LUT 210 can be expressed as FIG. 5, the conversion characteristic of the toner saving LUT 211 is the one converting the input density values into the image density values ΔEn of the rate of about the half of the conversion characteristic of the normal LUT 210. This indicates that the conversion rules of the input density values of the normal LUT 210 and those of the toner saving LUT 211 are different from each other.

The toner saving LUT 211 is not one for compressing input density values to convert the input density values into output density values, but one for converting the input density values into the dither pattern numbers Pn having the values larger than the input density values. Consequently, the compression of the gradations of an image data is not performed unlike the related art.

Moreover, any of the dither pattern numbers Pn converted based on the density data of an image data has a different value from that of the other dither pattern numbers Pn also in the toner saving LUT 211, to say nothing of in the normal LUT 210. Image forming can consequently be performed without lessening the numbers of gradations capable of being reduced by the image forming apparatus 100 in both of the operational modes of the standard mode and the toner saving mode.

The CPU 17 changes the operational mode based on a user's operation of the operation display section 2, and reads the LUT corresponding to the operational mode from the ROM 18 to write the read LUT into the LUT memory 21. That is, when the standard mode is specified, the CPU 17 loads the normal LUT 210 into the LUT memory 21. When the toner saving mode is specified, the CPU 17 loads the toner saving LUT 211 into the LUT memory 21. Thereby, the CPU 17 switches the operational mode of the image forming.

The first and the second address converting circuits 31 and 32 are circuits converting the coordinate information x and y, respectively, output from the memory access control circuit 19 into the corresponding addresses of a dither dot order arrangement 330.

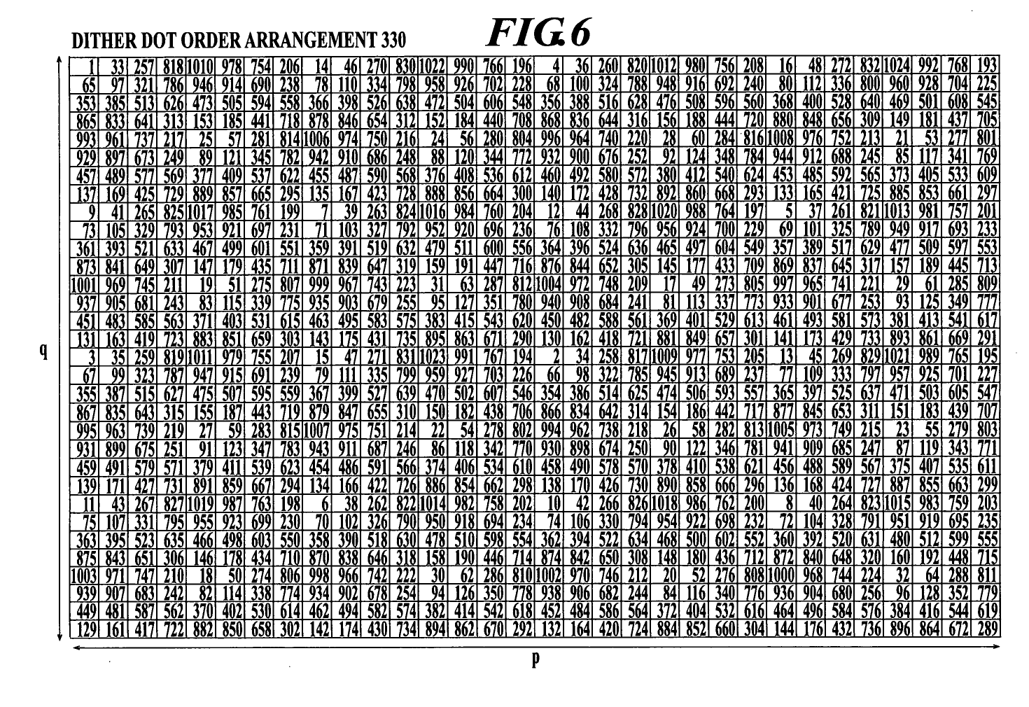

The dither memory 33 as a dither threshold value matrix is a memory storing the dither dot order arrangement 330 shown in FIG. 6. The dither dot order arrangement 330 is a two-dimensional arrangement of “p”×“q” (“p” and “q” are integers), and stores threshold values MD for determining whether the dots in the dither pattern is turned on (“1”).

The threshold values MD show the order of turning on the dots in the dither pattern with the increase of density data, and an identification value different from those of the other dots is set by the dot. Moreover, the threshold values MD are expressed as 11-bit numbers of gradations from 0 to 1024, and the coordinate information in the dither dot order arrangement 330 is associated as the row number “p” and the column number q

The dither dot order arrangement 330 shown in FIG. 6 comprises 1024 dots of 32×32, and each of the integer values from 1 to 1024 comprises a threshold value MD different from one another. By turning on the dots of an output image based on the threshold values MD, 1025 gradations at the maximum can be expressed.

The first address converting circuit 31 calculates an address Mx on the abscissa axis of the dither dot order arrangement 330 based on the following formula (a) based on the x-coordinate information output from the memory access control circuit 19, and outputs the calculated address Mx to the dither memory 33.
Mx=x mod p (a)

Moreover, the second address converting circuit 32 calculates an address My of the dither dot order arrangement 330 based on the following formula (b) based on the y-coordinate information output from the memory access control circuit 19, and outputs the calculated address My to the dither memory 33.
My=y mod q (b)

Incidentally, the “mod” shown in the formulas (a) and (b) is a remainder calculation formula, which is for calculating the remainder of the division of x by m and the remainder of the division of y by n. Moreover, the “p” in the formula (a) indicates the number of rows of the dither dot order arrangement 330, and the “q” indicates the number of columns thereof. The CPU 17 obtains the number of rows “p” and the number of columns “q” of the dither dot order arrangement 330 in advance, and outputs the numbers to the first address converting circuit 31 and the second address converting circuit 32.

When the addresses Mx and My output from the first address converting circuit 31 and the second address converting circuit 32, respectively, are input, the dither memory 33 sets the address Mx and My as the coordinates (Mx, My) of the dither dot order arrangement 330, and selects and reads the threshold value MD corresponding to the coordinates (Mx, My) from the dither dot order arrangement 330 to output the read threshold value MD to the comparator 34.

The comparator 34 compares the dither pattern number Pn output from the LUT memory 21 with the threshold value MD output from the dither memory 33, and determines whether a dot of the output image is turned on or off based on the comparison result. Specifically, when the dither pattern number Pn is equal to or more than the threshold value MD as the result of the comparison of the dither pattern number Pn with the threshold value MD, the comparator 34 outputs data “1,” which turns on the dot, to the writing processing unit 12. When the dither pattern number Pn is less than the threshold value MD, the comparator 34 outputs data “0,” which turns off the dot, to the writing processing unit 12.

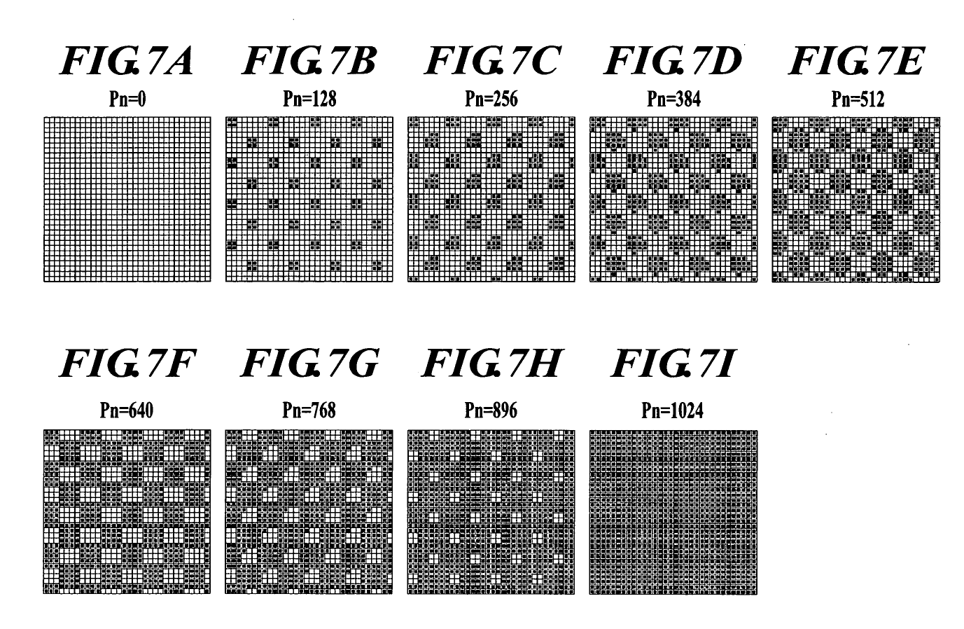

FIGS. 7A-7I show a part of the dither patterns to be generated based on the dither dot order arrangement 330. For example, when the dither pattern number Pn corresponding to the density data output from the image memory 14 is “0,” the dither pattern number Pn is smaller than any of the threshold values MD in the dither dot order arrangement 330 of FIG. 6. Consequently, a dither pattern in which all the dots are set to be off as shown in FIG. 7A is obtained. Moreover, when the dither pattern number Pn is “128,” a dither pattern shown in FIG. 7B is obtained by the comparison of the dither pattern number Pn with the dither dot order arrangement 330. As shown in FIGS. 7A-7I, dither patterns in which the areas of the dots being on increases as shown in FIGS. 7C, 7D, 7E, 7F, 7G, 7H, and 71 with the change of the dither pattern number Pn from 256 to 384, 512, 640, 768, 896, and 1024 in order.

That is, the dither dot order arrangement 330 can form the dither patterns linear in the numbers of dots, in which dither patterns the numbers of dots that are on are (comparatively) linearly increased as the rise of the density data. Incidentally, the dither patterns of FIGS. 7A-7I correspond to the dither patterns of 106 LPI and 45° at 600 dpi.

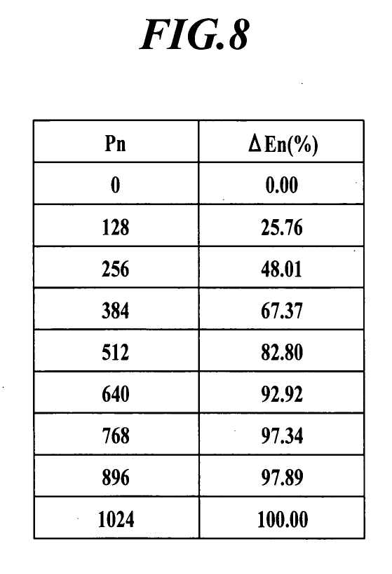

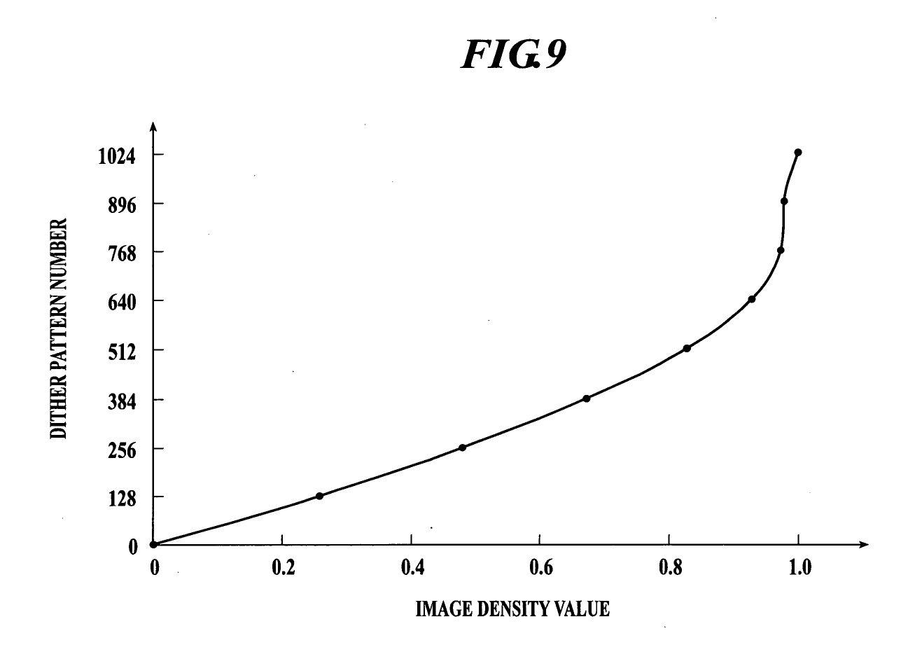

As described above, the relation between the dither pattern numbers Pn of the dither patterns formed based on the dither dot order arrangement 330 and the image density values ΔEn is not always in proportion to each other, but becomes the relation as shown in FIG. 8. From the relations between the dither pattern numbers Pn and the image density values ΔEn, which are shown in FIG. 8, a correlation based on a two-dimensional spline curve shown in FIG. 9 is obtained. The spline curve of FIG. 9 shows the correlation with the dither pattern numbers Pn to be used for obtaining desired image density values ΔEn.

For example, when the image density values ΔEn in a range of from 0% to 100% are desired, that is, at the time of the standard mode, the screening processing using a dither pattern including the dither pattern numbers Pn from 0 to 1024 is performed by converting an image data by using the normal LUT 210 storing the dither pattern numbers Pn from 0 to 1024.

Moreover, when the image density values ΔEn in a range of from 0% to 50% are desired, that is, at the time of the toner saving mode, the screen processing using a dither pattern including the dither pattern numbers Pn from 0 to 272 is performed by converting an image data by using the toner saving LUT 211 storing the dither pattern numbers Pn from 0 to 272.

Consequently, the screening module 20 can generate output images having density characteristics in which the image density values ΔEn are within a range of from 0% to 100% to the density data of from 0 to 255 at the time of the standard mode and the image density values ΔEn are lowered to be within a range of from 0% to 50% at the time of the toner saving mode.

As described above, according to the first embodiment, the normal LUT 210 and the toner saving LUT 211, which are produced by associating the density data of an input image with the dither pattern numbers Pn in the injective manner and by storing the associated density data and the dither pattern numbers Pn into them, are switched according to an operational mode to be stored in the LUT memory 21, and the density data of the input image is converted into the dither pattern numbers Pn, and further the dither pattern numbers Pn are compared with the threshold values MD read from the dither dot order arrangement 330. Thereby, the on and off of the dots of an output image are determined.

In the dither dot order arrangement 330, the threshold values MD are stored to linearly increase the number of dots as the rise of the values of the density data. Consequently, an output image having the same gradations as those of the input image can be obtained by performing the screening processing by using the dither dot order arrangement 330 at the time of the toner saving mode. Consequently, the screening processing can be performed to form an image without lessening the number of gradations of the output image to that of the input image at the both times of the standard mode and the toner saving mode.

[First Modification]

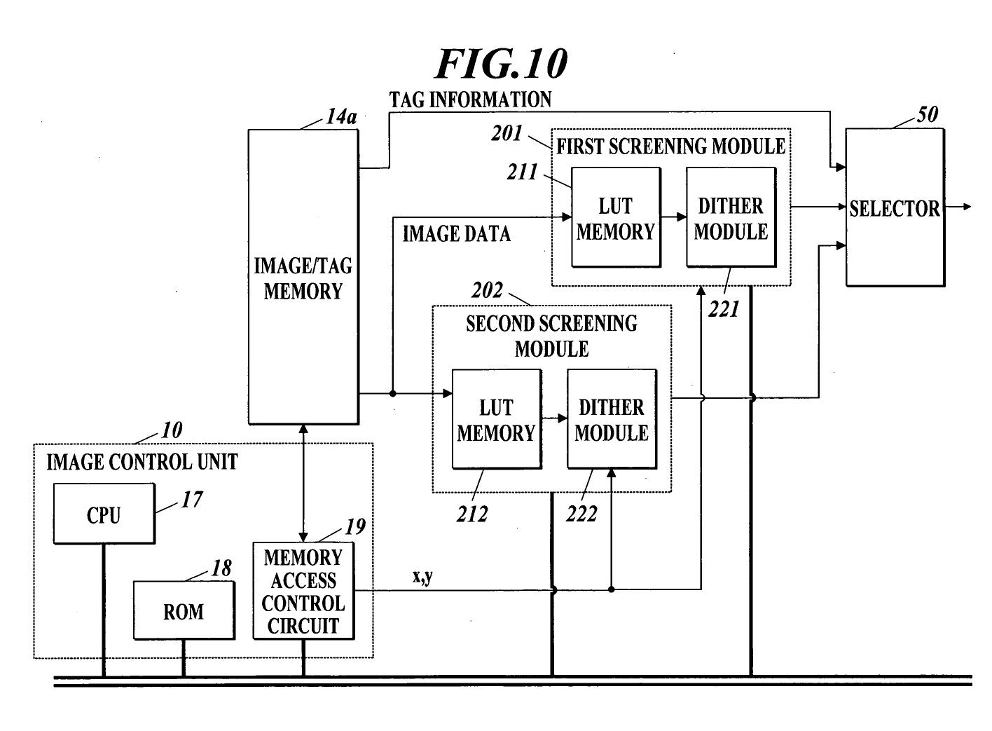

Next, a first modification of the first embodiment is described with reference to FIG. 10. The image forming apparatus 100 of the first modification is realized by replacing the image memory 14 in FIG. 1 with an image/tag memory 14a of FIG. 10, and by providing a first and second screening modules 201 and 202, and a selector 50, which are shown in FIG. 10, to the screen processing unit 16.

The image/tag memory 14a stores image data that is previously developed to a bitmap of the resolution of image forming and has dot gradations, and object tags. Hereupon, the object tag is the data indicating the kind of an object corresponding to a dot included in image data, and there are a text object, a graphics object, and an image object as the kinds of the objects.

The first screening module 201 comprises an LUT memory 211 and a dither module 221. The dither module 221 of the first screening module 201 stores the dither dot order arrangement 330 designed to give priority to the resolution properties for the text object, the graphics object, and the like.

The second screening module 202 comprises an LUT memory 212 and a dither module 222. The dither module 222 of the second screening module 202 stores another dither dot order arrangement 330 designed to give priority to the gradation properties for the image object and the like.

The LUT memories 211 and 212 store either the normal LUT 210 or the toner saving LUT 211 similarly to the first embodiment, and the switching of the LUTs to be stored is controlled by the CPU 17.

The image/tag memory 14a outputs the density data of image data per the dot to the first screening module 201 and the second screening module 202, and outputs the object tag corresponding to the dot to the selector 50.

Moreover, the memory access control circuit 19 outputs the coordinate information of the image data to the dither module 221 of the first screening module 201 and the dither module 222 of the second screening module 202. Because the operations of the LUT memories and the dither modules of the first and the second screening modules 201 and 202 are similar to those of the first embodiment mentioned above, their descriptions are omitted.

The selector 50 selects any one of the image data after the screening processing that is output from each of the first screening module 201 and the second screening module 202, and outputs the selected image data to the writing processing unit 12. To put it concretely, when an object tag output from the image/tag memory 14a indicates a character or a graphic, the selector 50 selects the output data from the first screening module 201. When the object tag indicates an image, the selector 50 selects the output data from the second screening module 202. The selector 50 outputs the selected output data to the writing processing unit 12.

As described above, by providing the screening module corresponding to the object of image data, the screening processing can be performed by using a gradation characteristic different according to the object included in an image data to form an image.

While the combination of specific kinds of objects for the data selection is exemplary mentioned in the abovementioned modification, a different combination of kinds of objects may be employed in the selector 50 in lieu of the combination explained above. Moreover, three dedicated screening modules may be provided for the three kinds of the objects, respectively.

[Second Modification]

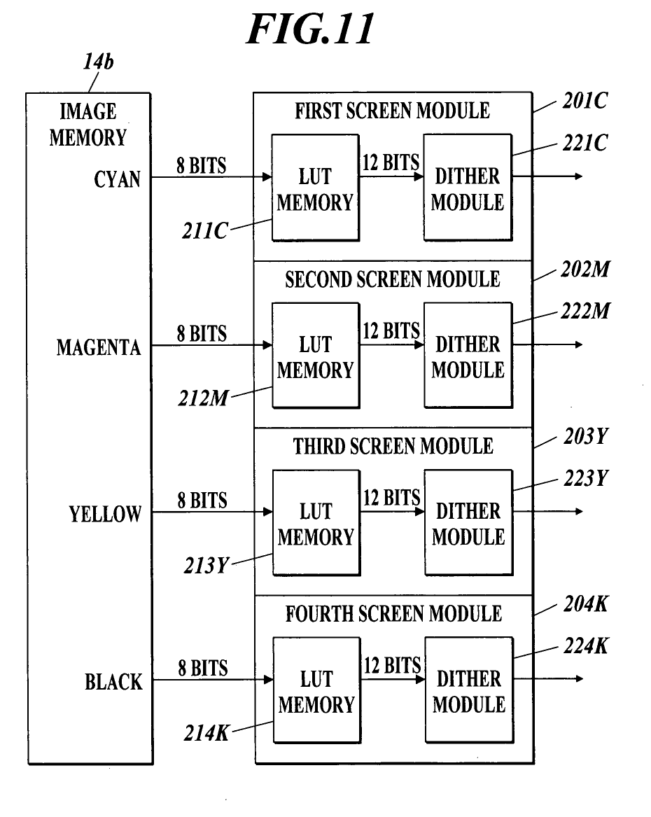

Next, a second modification of the first embodiment is described with reference to FIG. 11. The image forming apparatus 100 of the second modification is accomplished by replacing the image memory 14 of FIG. 1 with an image memory 14b of FIG. 11, and by providing a first to a fourth screening modules 201C, 202M, 203Y, and 204K; which are shown in FIG. 11, to the screen processing unit 16.

The image forming apparatus 100 of the second modification performs color image forming by using a plurality of toning materials (toners) of cyan (C), magenta (M), yellow (Y), and black (K). The image memory 14b outputs the density data of the image data corresponding to the respective toning materials to the first to the fourth screen modules 201C-204K.

In FIG. 11, the first screen module 201C performs a screening processing to the density data of a cyan color, and the second screen module 202M performs a screening processing to the density data of a magenta color. Moreover, the third screen module 203Y performs a screening processing to the density data of a yellow color, and the fourth screen module 204B performs a screening processing to the density data of a black color.

Each of the screening modules 201C, 202M, 203Y, and 204K stores a dither dot order arrangement 330 designed in consideration of a resolution property and a gradation property corresponding to the cyan color, the magenta color, the yellow color, or the black color, respectively. Moreover, each of the screening modules 201C, 202M, 203Y, and 204K includes each of LUT memories 211C-214K. Each of the LUT memories 211C-214K stores either the normal LUT 210 or the toner saving LUT 211 similarly to the first embodiment, and the switching of the LUT to be stored is controlled by the CPU 17.

As described above, by providing a screen module corresponding to each toning material, the screening processing can be performed by a gradation characteristic different for each toning material to form an image. Incidentally, the aforesaid configurations of the first modification and the second modification may be combined, and in this case the combined configuration can be achieved by providing the screen modules each capable of dealing with each of the toning materials and the object tags.

### Second Embodiment

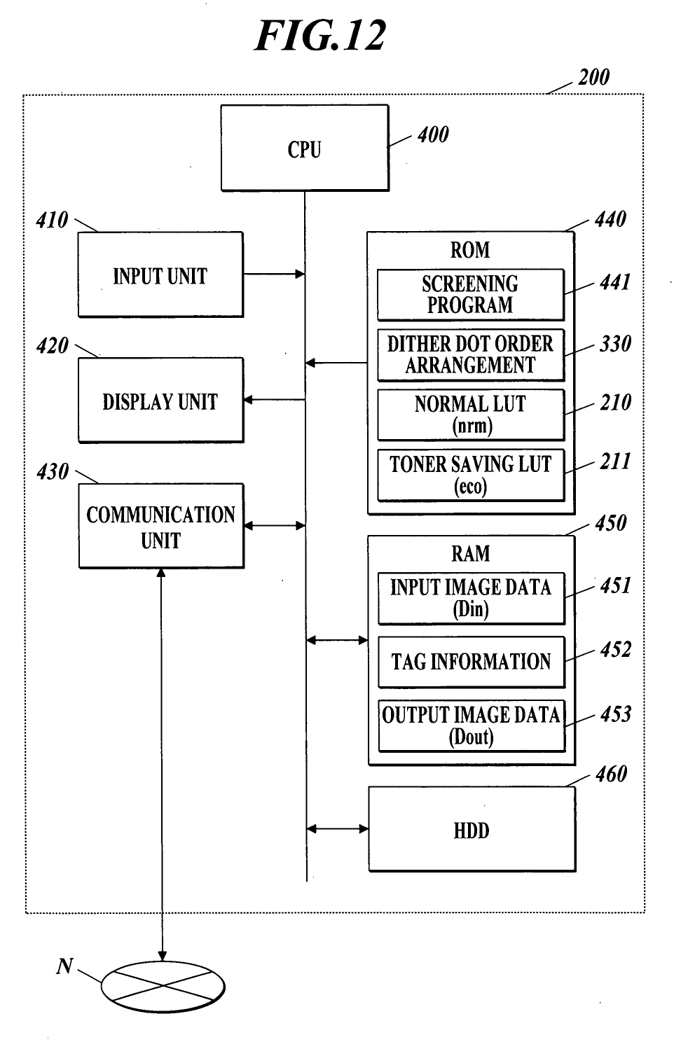

Next, a second embodiment of the present invention is described with reference to FIGS. 12-14C. Although the aforesaid first embodiment realizes the screening processing of the present invention by using hardware, the second embodiment realizes the screening processing by using software. Accordingly, it is set to perform the screening processing in the client terminal 200 shown in FIG. 1, and the setting is described in the following. That is, the client terminal 200 operates as the image processing apparatus performing the screening processing.

FIG. 12 is a block diagram showing an example of the functional configuration of the client terminal 200. According to FIG. 12, the client terminal 200 comprises a CPU 400, an input unit 410, a display unit 420, a communication unit 430, a ROM 440, a RAM 450, and an HDD 460.

The CPU 400 is a control unit that wholly manages and controls the client terminal 200 by performing the control of the operation of each function unit constituting the client terminal 200, the control of the data inputting and outputting between the function units, and the like. To put it concretely, the CPU 400 reads a program stored in the ROM 440 or the HDD 460 according to an operation signal input from the input unit 410, and executes the processing in accordance with the program. The CPU 400 then performs the update of the display screen of the display unit 420, the storage of data into the RAM 450 and the HDD 460, the data communication with an external device through the communication unit 430, and the like, based on the processing result.

The input unit 410 comprises a group of various keys, such as a cursor key and numeric keys, and a pointing device, such as a mouse and a touch panel. The input unit 410 outputs an operation signal corresponding to a key depressed by a user, and an operation signal corresponding to the coordinate position on a screen where is specified with the pointing device to the CPU 400.

The display unit 420 comprises a cathode-ray tube (CRT), an LCD, or the like, and performs the display or the like on a display screen based on the control of the CPU 400. The communication unit 430 comprises a LAN interface, a modem, or the like, and is a function unit performing data communication with an external device (such as the image forming apparatus 100) through the network N.

The ROM 440 is a data area storing various programs, data necessary for the execution of the program, and the like. According to FIG. 12, the ROM 440 stores a screening program 441, the normal LUT 210, the toner saving LUT 211, and the dither dot order arrangement 330.

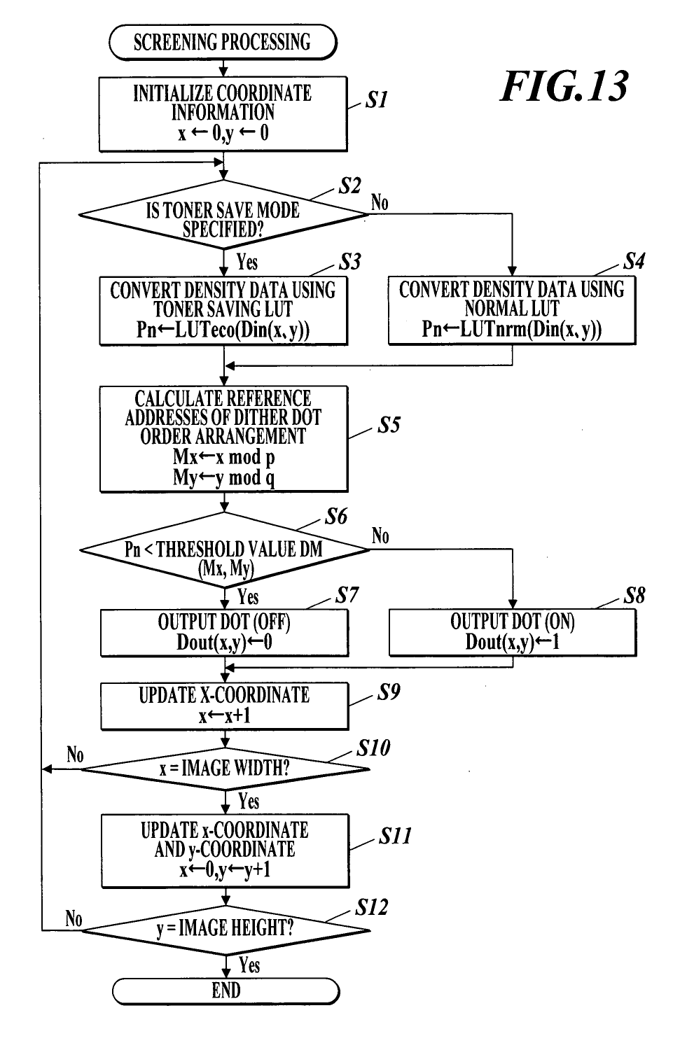

The screening program 441 is a program for realizing the screening processing shown in FIG. 13. The normal LUT 210, the toner saving LUT 211, and the dither dot order arrangement 330 severally have a data configuration similar to that of the first embodiment, which are shown in FIGS. 3, 4, and 6, and accordingly their descriptions are omitted. Incidentally, each of the dither pattern numbers Pn of the dither dot order arrangement 330 is expressed to have 1025 gradations of 11 bits similarly to that of the first embodiment, but it may be expressed by 4096 gradations of 12 bits. The number of gradations can suitably be changed according to the designing of software.

The RAM 450 is a memory area that temporarily stores the data pertaining to a program to be executed by the CPU 400 and can be read from and written into. According to the FIG. 12, the RAM 450 secures a data area for storing an input image data 451, tag information 452, and an output image data 453. The input image data 451 is the image data of an image processing target, and the output image data 453 is the image data after image processing. In the present embodiment, as the input image data 451, density data having 8-bit dot gradations with regard to the xy-coordinate system is stored. On the other hand, as the output image data 453, which is image data having been image-processed, density data of bi-level (1-bit) dot gradations with regard to the xy-coordinate system is stored. Moreover, as the tag information 452, the object tag data for each dot of the input image data 451 is stored with regard to the xy-coordinate system. Hereupon, the object tag is data indicating the kind of an object corresponding to a dot included in the image data, and there are a text object, a graphics object, and an image object as the kinds of the object.

The HDD 460 is a function unit performing the reading and the writing of data from and to the HD, and, for example, stores the image data of the target of image processing therein. The image data is read from the HDD 460 as the input image data 451 to be stored in the RAM 450. The input image data 451 that has been subjected to the screening processing by the CPU 400 is then stored in the RAM 450 as the output image data 453.

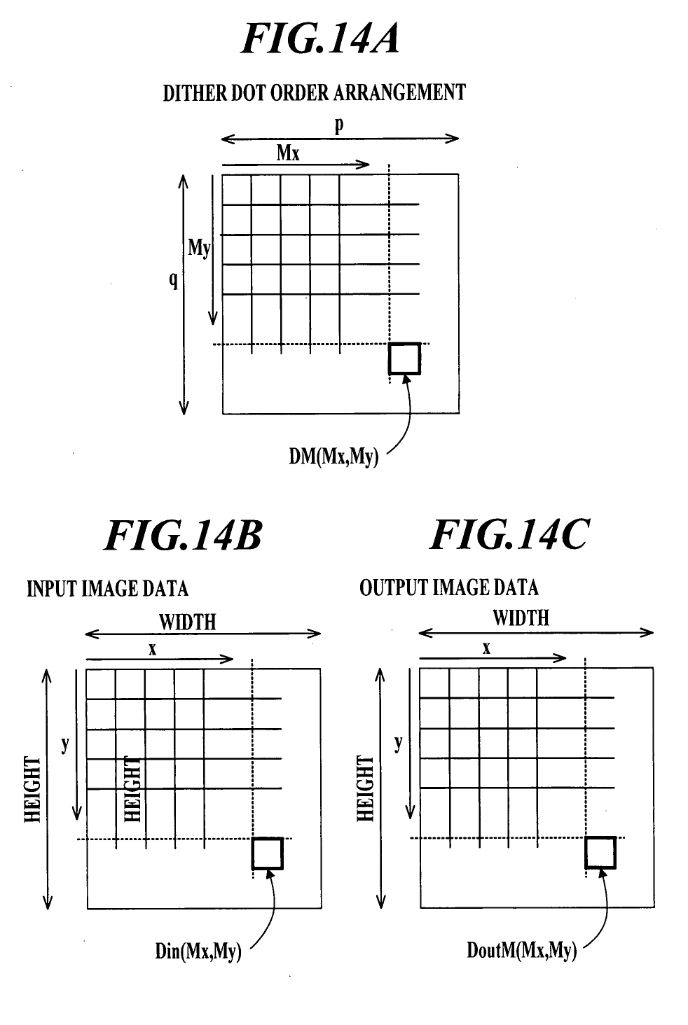

Next, the concrete operation of the client terminal 200 is described with reference to FIGS. 13 and 14A-14C. The CPU 400 of the client terminal 200 first reads the screening program 441 from the ROM 440 to expand the read screening program 441 in the RAM 450, and thereby starts the screening processing in accordance with the screening program 441.

The CPU 400 then initializes the coordinate information of the x-coordinate and the y-coordinate of a dot of an image processing target (Step S1), and judges whether the toner saving mode is specified as the operational mode of the image forming apparatus 100 based on a user's operation of the operation display section 2 (Step S2).

At this time, when the CPU 400 judges that the toner saving mode is specified (Step S2; Yes), the CPU 400 reads the density data Din(x, y) of the dot of the image processing target from the input image data 451 as shown in FIG. 14B, and reads the dither pattern number Pn associated with the density data from the toner saving LUT 211(eco) (Step S3).

Moreover, when the CPU 400 judges that the toner saving mode is not specified, that is, the standard mode is specified (Step S2; No), the CPU 400 reads the dither pattern number Pn associated with the density data Din(x, y) of a dot of the input image data 451 from the normal LUT 210(nrm) (Step S4).

Incidentally, the LUTeco(X) at the Step S3 in FIG. 13 denotes a subroutine function for reading the dither pattern number Pn corresponding to density data X from the toner saving LUT 211, and the LUTnrm(X) at the Step S4 denotes a subroutine function for reading the dither pattern number Pn corresponding to the density data X from the normal LUT 210.

After the CPU 400 has converted the 8-bit density data into the 16-bit dither pattern number Pn at the Step S3 or S4, the CPU 400 calculates the reference addresses Mx and My of the dither dot order arrangement 330 by a calculation method similar to that of the first embodiment (Step S5). The CPU 400 then reads the threshold value MD of the dither dot order arrangement 330 at the reference addresses Mx and My as shown in FIG. 14A, and judges whether the threshold value MD is larger than the dither pattern number Pn read at the Step S3 or S4 (Step S6).

When the CPU 400 judges that the threshold value MD is larger than the dither pattern number Pn (Step S6; Yes), the CPU 400 sets “0” to the density data Dout(x, y) on the coordinates of the image processing target of the output image data 453 shown in FIG. 14C, and turns off the output dot (Step S7). Moreover, when the CPU 400 judges that the threshold value MD is equal to the dither pattern number Pn or less (Step S6; No), the CPU 400 sets the density data Din(x, y) to “1” to turns on the output dot (Step S8).

The CPU 400 adds one to the x-coordinate of the dot of the image processing target after the processing at the Step S7 or S8 to update the x-coordinate, and repeats the processing of the Steps S2-S9 until the x-coordinate reaches the width of the input image data 451. When the CPU 400 judges that the x-coordinate has reached the width of the input image data 451 based on the tag information 452 (Step S10; Yes), the CPU 400 sets the x-coordinate of the dot of the image processing target to “0,” and adds one to the y-coordinate to update the y-coordinate (Step S11). The CPU 400 repeats the processing of the Steps S2-S11 until the y-coordinate becomes the height of the input image data 451.

As described above, by performing the processing at the Steps S2-S8 to each density data of the input image data 451, the screening processing is executed by using the different LUTs in the standard mode and in the toner saving mode.

As described above, according to the second embodiment, the screening processing, which is realized by the configuration of hardware in the first embodiment, can be realized by software. Consequently, the screening processing can be performed without lessening the number of gradations of an image at both the time of the standard mode and the toner saving mode, similarly to the first embodiment.

Incidentally, although the description has been performed on the supposition that the normal LUT 210, the toner saving LUT 211, and the dither dot order arrangement 330 are previously stored in the ROM 440, these pieces of data may be obtained from, for example, a not-shown external file to be stored in the RAM 450 or the HDD 460.

Moreover, the screening processing dealing with the objects of the image data and the screening processing dealing with the color materials, both of which have been described in the modifications of the first embodiment, may be realized by software.

Moreover, the description has been given on the supposition that the LUTs, each previously determining the correlation between the dither pattern numbers Pn and the image density values ΔEn forming an image actually, are stored, for example, the LUTs may be treated as follows. That is, at the time of the calibration of the image forming apparatus 100, a patch image of a plurality of patterns of the dither screens is formed, and the density values of the patch image are measured with a CCD camera, a spectral photometer, or the like. The CPU calculates the correlation between the dither pattern numbers Pn and the image density values ΔEn by approximate calculations or the like based on the density values of the measurement results.

Next, the CPU corrects the normal LUT 210 and the toner saving LUT 211 based on the calculated correlation between the dither pattern numbers Pn and the image density values ΔEn, and may determine each LUT. Hereby, it is possible to correct each LUT according to a change of the gradation characteristic at the time of image forming owing to the aged deterioration of the image forming apparatus 100 and the heat produced in the inner circuits thereof.

What is claimed is:

1. An image processing circuit, comprising:
a converting section to perform an injective conversion for a gradation data of an input image to a gradation data indicating any one of dither patterns having the number of gradations higher than the number of gradations of the input image;
a dither processing section to select the gradation data in the dither patterns, corresponding to coordinate information of a dot of an image processing target in the input image; and
a screening processing section to determine a gradation data of a dot of an output image based on the gradation data for which the injective conversion is performed by the converting section and the gradation data selected by the dither processing section.

2. The image processing circuit of claim 1, further comprising a switching section to switch a conversion rule of the converting section, wherein
the converting section performs the injective conversion for the gradation data of the input image to the gradation data indicating any one of the dither patterns in accordance with the conversion rule switched by the switching section.

3. The image processing circuit of claim 1, wherein
the dither processing section comprises:
a dither storing unit to store the gradation data which are different among dots in a predetermined coordinate system; and
a pattern selecting unit to select the gradation data corresponding to the coordinate information of the dot of the image processing target in the input image, from the dither storing unit.

4. The image processing circuit of claim 1, wherein
the gradation data includes identification values for identifying each of the dither patterns, and
the screening processing section determines the gradation data of the dot of the output image based on whether or not the identification value converted by the converting section is equal to or more than the identification value selected by the dither processing section.

5. A computer-readable medium for storing a program, wherein the program causes a computer to realize functions as:
a converting section to perform an infective conversion for a gradation data of an input image to a gradation data indicating any one of dither patterns having the number of gradations higher than the number of gradations of the input image;
a dither processing section to select the gradation data in the dither patterns, corresponding to coordinate information of a dot of an image processing target in the input image; and
a screening processing section to determine a gradation data of a dot of an output image based on the gradation data for which the injective conversion is performed by the converting section and the gradation data selected by the dither processing section.

6. An image processing method, comprising:
performing an injective conversion for a gradation data of an input image to a gradation data indicating any one of dither patterns having the number of gradations higher than the number of gradations of the input image;
selecting the gradation data in the dither patterns, corresponding to coordinate information of a dot of an image processing target in the input image; and
determining a gradation data of a dot of an output image based on the gradation data for which the injective conversion is performed by the performing of the injective conversion and the gradation data selected by the selecting of the gradation data.

7. An image processing apparatus, comprising:
a dither threshold value matrix having a reproducing ability for N gradations; and
a look-up table to perform an injective conversion for a gradation data having M gradations lower than the N gradations to a gradation data having the N gradations, wherein
the injective conversion is performed for the gradation data of an input image having the M gradations to the gradation data having the N gradations by using the look-up table, and a screening processing is executed for the gradation data for which the injective conversion is performed, by using the dither threshold value matrix.

8. The image processing apparatus of claim 7, wherein the screening processing is executed by using a selected look-up table among a plurality of look-up tables having different infective conversion characteristics from one another.

9. The image processing apparatus of claim 8, wherein the look-up table is selected according to an instruction of a user.

10. The image processing apparatus of claim 8, wherein one of the plurality of look-up tables performs the injective conversion for at least a part of a gradation area of the gradation data having the N gradations, to a gradation data having the M gradations, which has a lower density than that of the other look-up tables.

11. The image processing apparatus of claim 7, wherein the dither threshold value matrix is a dither threshold value matrix for generating dither patterns linear in the number of dots.

12. An image processing method comprising:
performing an injective conversion for a gradation data of an input image having M gradations to a gradation data having N gradations by using a look-up table for performing the injective conversion for the gradation data having the M gradations lower than the N gradations to the gradation data having the N gradations; and
executing a screening processing for the gradation data for which the injective conversion is performed by using a dither threshold value matrix having a reproducing ability for the N gradations.

13. The image processing method of claim 12, wherein the executing of the screening processing is executed by using a selected look-up table among a plurality of look-up tables having different injective conversion characteristics from one another.

14. The image processing method of claim 13, wherein the look-up table is selected according to an instruction of a user.

15. The image processing method of claim 13, wherein one of the plurality of look-up tables performs the injective conversion for at least a part of a gradation area of the gradation data having the N gradations, to a gradation data having the M gradations, which has a lower density than that of the other look-up tables.

16. The image processing method of claim 12, wherein the dither threshold value matrix is a dither threshold value matrix for generating dither patterns linear in the number of dots.

17. A computer-readable medium for storing a program, wherein the program causes a computer to realize functions as:
a storage section to store a dither threshold value matrix having a reproducing ability for N gradations, and a look-up table performing an injective conversion for a gradation data having M gradations lower than the N gradations to a gradation data having the N gradations; and
a screening processing section to perform an injective conversion for the gradation data of an input image having the M gradations to the gradation data having the N gradations by using the look-up table, and to execute a screening processing by using the dither threshold value matrix to the gradation data for which the injective conversion is performed.

18. The computer-readable medium for storing the program of claim 17, wherein the screening processing is executed by using a selected look-up table among a plurality of look-up tables having different injective conversion characteristics from one another.

19. The computer-readable medium for storing the program of claim 18, wherein the look-up table is selected according to an instruction of a user.

20. The computer-readable medium for storing a program of claim 18, wherein one of the plurality of look-up tables performs the injective conversion for at least a part of a gradation area of the gradation data having the N gradations, to a gradation data having the M gradations, which has a lower density than that of the other look-up tables.

21. The computer-readable medium for storing the program of claim 17, wherein the dither threshold value matrix is a dither threshold value matrix for generating dither patterns linear in the number of dots.
